(19) United States
(12) Patent Application Publication
(10) Pub. No.: US 2013/0263863 A1
(43) Pub. Date: Oct. 10, 2013

(54) WOUND CARE APPARATUS AND METHODS FOR USING THE SAME

(71) Applicants: Jeff Baker, Cottonwood Heights, UT (US); Darren Walters, Layton, UT (US); Brad Baker, Riverton, UT (US)

(72) Inventors: Jeff Baker, Cottonwood Heights, UT (US); Darren Walters, Layton, UT (US); Brad Baker, Riverton, UT (US)

(21) Appl. No.: 13/904,816

(22) Filed: May 29, 2013

Related U.S. Application Data
(63) Continuation-in-part of application No. 13/084,080, filed on Apr. 11, 2011.
(60) Provisional application No. 61/652,839, filed on May 29, 2012.
(60) Provisional application No. 61/693,240, filed on Aug. 24, 2012.

(51) Int. Cl. A61G 15/12

(52) U.S. Cl. CPC A61G 15/12
USPC 128/845

(57) ABSTRACT

A wound care apparatus having a first surface for supporting a first portion of a patient's leg and a second surface for supporting a second portion of the leg. Generally, the apparatus includes a leg support that includes the first the second surfaces, wherein the first surface is configured to support the patient's calf and the second surface is configured to support the patient's foot. In some cases, the leg support includes a pivot joint that allows the support to pivot between a first position that presents the first surface and a second position that presents the second surface. In some instances, the leg support is further configured such that when it is in the first position, a lowest support portion of the first surface is lower than is a lowest support portion of the second surface when the leg support is in the second position. Other implementations are described.

### CROSS REFERENCE TO RELATED APPLICATIONS

This application is a continuation-in-part of U.S. patent application Ser. No. 13/084,080 (Attorney Docket No. 14555.8), entitled WOUND CARE APPARATUS AND METHODS FOR MAKING THE SAME, filed Apr. 11, 2011, and claims priority to U.S. Provisional Patent Application Ser. No. 61/652,839 (Attorney Docket No. 14555.10), entitled WOUND CARE APPARATUS AND METHODS FOR USING THE SAME, filed May 29, 2012, and claims priority to U.S. Provisional Patent Application Ser. No. 61/693,240 (Attorney Docket No. 14555.12), entitled WOUND CARE APPARATUS AND METHODS FOR USING THE SAME, filed Aug. 24, 2012, all of which are incorporated herein in their entirety for all that they disclose.

### BACKGROUND OF THE INVENTION

1. Field of the Invention

The present invention relates generally to systems and methods for treating a leg of a patient. In particular, at least some embodiments of the present invention relate to a wound care apparatus having a dual feature for supporting various anatomical surfaces of a patient's lower extremities (such as a patient's calf and foot).

2. Background and Related Art

The process of wrapping a patient's foot following an injury or medical procedure often requires the patient's foot to be suspended in air for a period of time. In this manner, a healthcare provider can have complete access to the patient's leg so as to be able to wrap a bandage around a portion of the patient's foot and leg. In some cases, where the patient has sufficient strength, the patient can lift and hold his or her leg and foot in a suspended position during the wrapping procedure. In other cases, however, the patient may be unconscious, physically incapable of lifting and holding the patient's leg at a desired height and for a desired period of time, or the patient would be uncomfortable holding the leg during the wrapping procedure. As a result, in such cases, the patient's leg will typically need to be supported in some other manner.

In this regard, to properly support a patient's leg during a wrapping procedure, a healthcare provider may, from time to time, need to have one or two additional individuals hold the patient's leg while the healthcare provider completes the wrapping. In still other instances, to hold the patient's leg in a desired position, the healthcare provider may choose to use his or her body to support the patient's leg during the wrapping procedure. For example, during the wrapping procedure, the healthcare provider may rest the patient's leg or foot on the provider's lap, hip, chest, or shoulder.

While the techniques described above have proven useful for supporting patients' legs during procedures that involve wrapping a patient's calf and/or foot, such techniques are not necessarily without their shortcomings. For example, where a healthcare provider needs one or two other individuals (which may likely be other healthcare providers or technicians) to hold a leg during a wrapping procedure, such a procedure may be a somewhat inefficient use of the other individuals' time. Additionally, where a healthcare provider uses his or her body to support the leg of a patient (especially the heavy leg of an obese patient), the healthcare provider may strain or otherwise injure themselves (e.g., their back, shoulder, etc.).

Thus, while techniques currently exist for treating and wrapping a patient's leg, challenges still exist. Accordingly, it would be an improvement in the art to augment or even replace current techniques with other techniques.

### SUMMARY OF THE INVENTION

The present invention relates generally to systems and methods for treating a leg of a patient. Further, the present invention relates to systems and methods for providing access for treatment by other healthcare providers, such as podiatrists or chiropodists. In particular, at least some embodiments of the present invention relate to a wound care apparatus having a dual feature for supporting various anatomical surfaces of a patient's lower extremities (such as the patient's calf and foot).

Although the described wound care apparatus can comprise any suitable component, some implementations of the apparatus include a leg support that includes a first surface (which is configured to support a patient's calf) and a second surface (which is configured to support the patient's foot (e.g., heel). In some cases, the leg support further includes a pivot joint that allows the support to pivot between a first position that presents the first surface and a second position that presents the second surface. In some instances, the leg support is further configured such that when it is in the first position, a lowest support portion of the first surface is lower than is a lowest support portion of the second surface when the leg support is in the second position.

In some implementations, the described apparatus further includes a leg support having a first surface that is configured to support a calf of a patient's leg, a second surface that is configured to support at least one of a heel and a foot of the patient's leg, and a first pivot joint that allows the leg support to pivot between a first position that presents the first surface to support the patient's leg and a second position that presents the second surface to support the patient's leg. In some such implementations, the leg support is configured such that the first surface supports and contacts (either directly or indirectly) the calf of the patient's leg when the leg support is in the first position and the patient's leg is substantially extended, and such that the second surface supports and contacts at least one of the heel and the foot when the leg support is in the second position and the patient's leg is substantially extended. In this regard, the apparatus can support the patient's leg in the described manner while the patient remains in substantially the same location (e.g., sitting or otherwise disposed on a patient support device) and while the wound care apparatus (as opposed to the first and second surfaces) maintains its relative location with respect to the patient support device.

In some implementations, the described invention further relates to a method for supporting a leg. While the method can include any suitable element, in some implementations, the method includes providing a leg support that includes a first surface that is configured to support a calf of a patient's leg, a second surface that is configured to support at least one of a heel and a foot of the patient's leg, and a first pivot joint that allows the leg support to pivot between a first position that presents the first surface to support the patient's leg and a second position that presents the second surface to support the patient's leg. In some such implementations, the leg support is configured such that when the leg support is in the first position, a lowest support portion of the first surface is lower than a lowest support portion of the second surface when the leg support is in the second position. Additionally, in some implementations, the method further includes supporting the patient's leg on the first surface when the leg support is in the first position. Furthermore, in some instances, the method includes supporting the patient on a patient support device and supporting the leg support on a support structure, wherein the support structure and the patient support device are separate and discrete from each other.

While the methods and processes of the present invention can be particularly useful in the area of wrapping a patient's foot, ankle, and/or calf, those skilled in the art can appreciate that the methods and processes can be used in a variety of different applications and in variety of different areas. For example, instead of simply using the described apparatus to wrap a patient's leg, the described apparatus can be used for any other suitable treatment and/or observation of the patient's leg, including, without limitation, for massaging, stitching, casting, etc.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1A depicts a perspective view of a representative embodiment of a wound care apparatus in a first position;

FIG. 1B depicts a side plan view of a representative embodiment of the wound care apparatus in the first position;

FIG. 2A depicts another perspective view of a representative embodiment of the wound care apparatus in the first position supporting a patient's leg;

FIG. 2B depicts a side plan view of an embodiment of an articulated chair having a representative embodiment of the wound care apparatus in the first position, supporting the patient's leg, shown in phantom;

FIG. 2C depicts a perspective view of the articulated chair having the wound care apparatus in the first position in accordance with a representative embodiment of the present invention;

FIGS. 3A-3B each illustrate a perspective view of the wound care apparatus coupled to a tripod in accordance with a representative embodiment of the present invention;

FIGS. 3C-3D each illustrate a perspective view of the wound care apparatus coupled to a wheeled base in accordance with a representative embodiment of the present invention;

FIG. 3E depicts a perspective view of a bed coupled to the wound care apparatus, in accordance with a representative embodiment of the present invention;

FIG. 4A depicts a perspective view of a representative embodiment of the wound care apparatus in a second position in accordance with a representative embodiment of the present invention;

FIG. 4B depicts a side plan view of a representative embodiment of the wound care apparatus in the second position;

FIG. 5A depicts a perspective view of the wound care apparatus and a receiver for selectively coupling the wound care apparatus to a leg rest in accordance with a representative embodiment of the present invention;

FIG. 5B depicts a plan view of the wound care apparatus and receiver for selectively coupling the wound care apparatus to the leg rest in accordance with a representative embodiment of the present invention;

FIG. 6A depicts a perspective view of the articulated chair having the wound care apparatus in the second position in accordance with a representative embodiment of the present invention;

FIG. 6B depicts a side plan view of the articulated chair having the wound care apparatus in the second position in accordance with a representative embodiment of the present invention;

FIG. 6C depicts another perspective view of a representative embodiment of the wound care apparatus in the second position;

FIGS. 7A-7C depict various views of a representative embodiment of the wound care apparatus in the first position;

FIGS. 7D-7F depict various views of a representative embodiment of the wound care apparatus in the second position;

FIGS. 8A-8C depict various views of a representative embodiment of the wound care apparatus in the first position;

FIGS. 8D-8F depict various views of a representative embodiment of the wound care apparatus in the second position;

FIGS. 9A-9C depict various views of a representative embodiment of the wound care apparatus in the first position; and

FIGS. 9D-9F depict various views of a representative embodiment of the wound care apparatus in the second position.

### DETAILED DESCRIPTION OF THE INVENTION

The present invention relates generally to systems and methods for treating a leg of a patient. In particular, at least some embodiments of the present invention relate to a wound care apparatus having a dual feature for supporting various anatomical surfaces of a patient's lower extremities.

While the described wound care apparatus can comprise any suitable component, in some embodiments, the apparatus comprises a first surface that is configured to directly support a first portion of a patient's leg (e.g., the patient's calf) and a second surface that is configured to support a second portion of the patient's leg (e.g., the patient's foot or heel). Additionally, in some embodiments, the apparatus includes at least one pivot joint that allows a healthcare provider (or any other user) to switch the apparatus between a first position, which places the first surface in a position to contact and otherwise support the patient's calf, and a second position, which places the second surface in a position to contact and otherwise support the patient's foot or heel. To provide a better understanding of the wound care apparatus, a more detailed description of the various components of the apparatus is provided below.

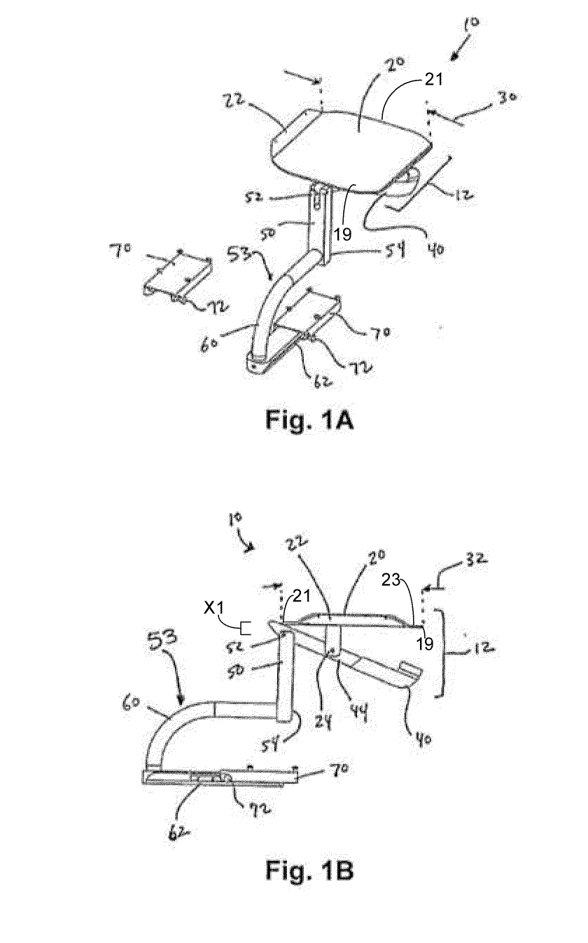

Referring now to FIGS. 1A and 1B, a representative embodiment of the wound care apparatus 10 in accordance with the present invention is shown in the first position. Although the wound care apparatus can comprise any suitable component that allows it to support a lower portion of a patient's leg, FIGS. 1A and 1B show that, in some embodiments, the apparatus 10 generally includes a leg support 12 having the first surface 20 for supporting a first portion of a patient's leg. While the first surface can support any suitable portion of a patient's leg, in some embodiments, the first surface is configured to contact or otherwise directly support (including with or without clothing, padding, bandaging etc. between the first surface and the patient's leg) a portion of the patient's leg that is disposed between the patient's knee and heel (e.g., the patient's calf).

The first surface 20 can comprise any suitable component or characteristic that allows it to support a first portion (e.g., calf) of a patient's leg. Indeed, FIG. 1A shows that, in some embodiments, the first surface 20 comprises a calf support having a width 30 sufficient to accommodate placement of the patient's calf. In some embodiments, the first surface 20 is optionally configured to have a length 32 approximately equal to an average length of a desired patient's (e.g., an adult's, child's, adolescent's, etc.) triceps surae. Additionally, in some embodiments, the first surface 20 further comprises one or more side guards 22 configured to prevent the patient's calf from being unintentionally displaced from the first surface 20.

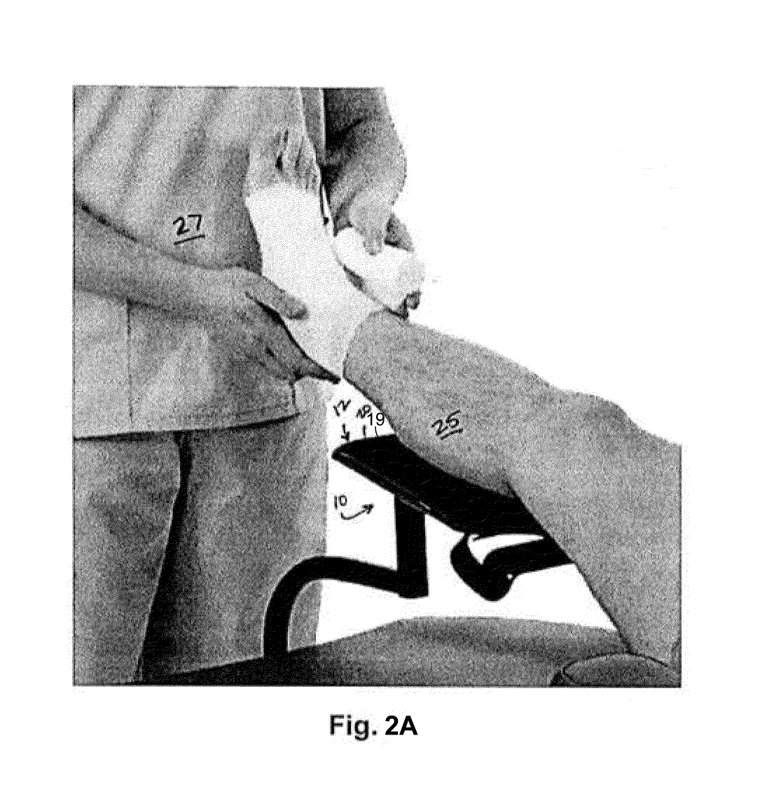

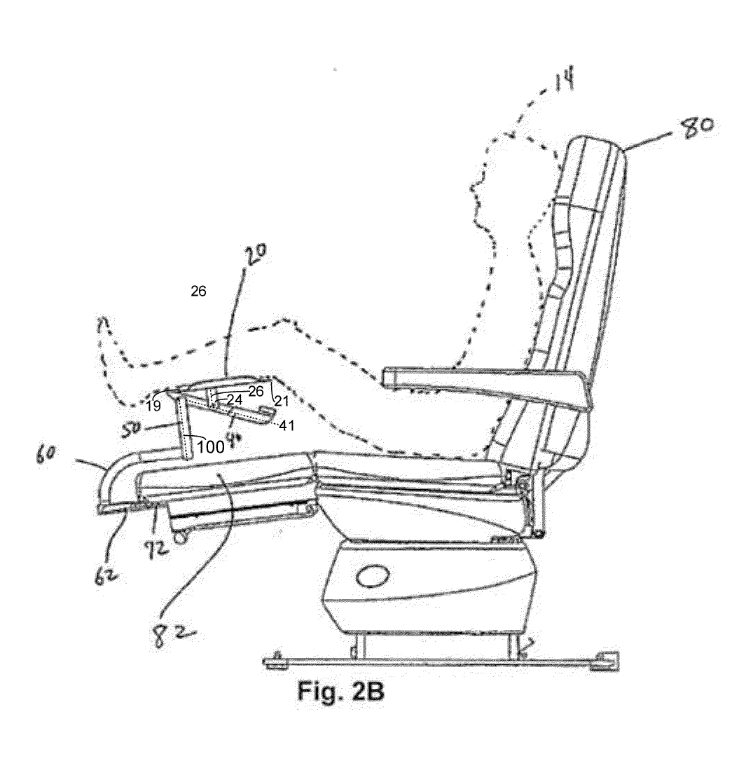

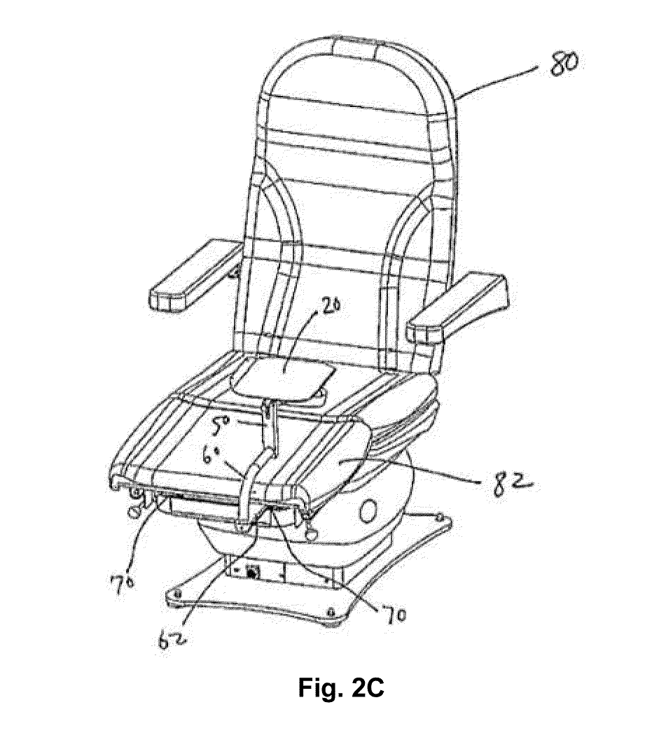

Accordingly (and as shown in FIG. 2A), when the patient's leg 25 is supported by the first surface 20, the foot and ankle of the patient are able extend beyond a distal end 19 of the first surface 20, thereby suspending the foot and ankle of the patient to provide 360° of access to these portions of the patient's lower extremities. Thus, in some embodiments, when the wound care apparatus 10 is in the first position, it is able to support the patient's leg such that the patient's foot and/or heel can be treated. For instance, FIG. 2A shows that, in some embodiments, when the patient's leg 25 is supported by first surface 20, the patient's foot and ankle extend beyond the distal end 19 of the first surface 20, thereby suspending the patient's foot and ankle and providing the healthcare provider 27 with the ability to freely wrap or otherwise attend to the patient's foot and/or heel (or any part of the patient's leg 25 that is not in direct contact with a surface of the wound care apparatus).

In some embodiments, the first surface 20 further comprises a connector 24 (e.g., a support strut, connection point, pivot point, etc.) that is fixedly coupled to an underside of the first surface 20, and is pivotally coupled to a support strut portion 44 of the second surface 40 (which is described below). As such, the first surface 20 is capable of pivoting in forward and rearward directions (e.g., as teeter totter or first degree lever) to accommodate various angles of contact for the patient's calf. This pivoting feature provides adjustability, thereby allowing the leg support 12 to be used with patients of varying heights, and to accommodate and move with movements of the patient's leg. Further, in some embodiments, the connector 24 is pivotally coupled to the underside of the first surface 20, thereby providing axial rotation of the first surface 20 relative to a vertical axis of connector 24. In still other embodiments, FIG. 2B shows that, the connector 24 provides the first surface 20 with a wide degree of pivotal mobility (e.g., in a single plane) with respect to the second surface's support strut 44. Indeed, in some embodiments (which are not directly shown), the connector 24 is configured such that a longitudinal or vertical axis 26 of the connector 24 is able to be pivoted to be perpendicular with a longitudinal axis 41 of the support strut 44.

Where the connector 24 is disposed on the underside of the first surface 20, the connector can be disposed in any suitable location that allows the first surface to pivot with respect to the support strut 44 to which it is connected. Indeed, in some embodiments, the connector is disposed in any suitable location between the first surface's distal end 19 (e.g., the end farthest from the patient when the leg support 12 is in the first position) and the first surface's proximal end 21 (e.g., the end closest to the patient). In some embodiments, however, the connector is optionally offset from a central location on the underside of the first surface such that a majority of the length of the first surface is disposed on a proximal side of the connector. While such a placement of the connector can serve any suitable function, in some instances, it allows the unbalanced first surface to be biased to lean down towards the patient.

Where the connector 24 is disposed closer to the first surface's distal end 19 than to the first surface's proximal end 21, the connector can be disposed in any suitable location, including, without limitation, between a midpoint of the length of the first surface 20 and a point that is distal to the first surface's distal end. In some embodiments, however, the connector is disposed distally between about 55% and about 99% of the length of the first surface. In other embodiments, the connector is disposed distally between about 60% and about 80% of the length of the first surface. In still other embodiments, the connector is disposed between about 65% and about 75% of the length of the first surface. In yet other embodiments, the connector is disposed distally within any sub-range of the aforementioned ranges.

In some embodiments (as shown in FIGS. 1A and 1B), the wound care apparatus 10 further comprises an attachment member 50 having a first end 52 that is pivotally coupled (e.g., via a fixed pivot point that allows pivoting in a single plane, or any other suitable pivot mechanism) to a terminal end of the support strut 44, and a second end 54 that is part of (or that is fixedly and/or removably coupled to) a support structure. In this regard, the second end 54 of the attachment member 50 can be coupled to any suitable support structure that is capable of supporting the wound care apparatus 10 and a patient's leg. Some non-limiting examples of such support structures include an extension arm that is capable of coupling the attachment member 50 to another support structure, a tripod, a bipod, a unipod, a stool, a chair (e.g., an examination chair, a non-articulated chair, an articulated chair, etc.), a bed (e.g., an articulated bed, a hospital bed, a non-articulated bed, etc.), a gurney, a table (e.g., an articulated table, a non-articulated table, an examination table, a surgery table, etc.), a traction device (e.g., a traction table, a chair, a bed, etc.), a stretcher, a wheeled base (e.g., a chair base, a cart, a wheel chair, a wheeled stand, a cart, a wagon, etc.), a bench, a piece of furniture, and/or virtually any other structure that is capable of supporting the wound care apparatus 10 and a patient's leg.

In one example of a suitable support structure, FIGS. 1A and 1B each show a representative embodiment in which the support structure 53 comprises an extension arm 60, which, in turn, is connectable to another support structure (e.g., a bed, a table, chair, tripod, etc.). By way of illustration, FIGS. 2B and 2C show embodiments in which the extension arm 60 couples the attachment member 50 to an articulated chair 80 (e.g., via leg rest portion 82).

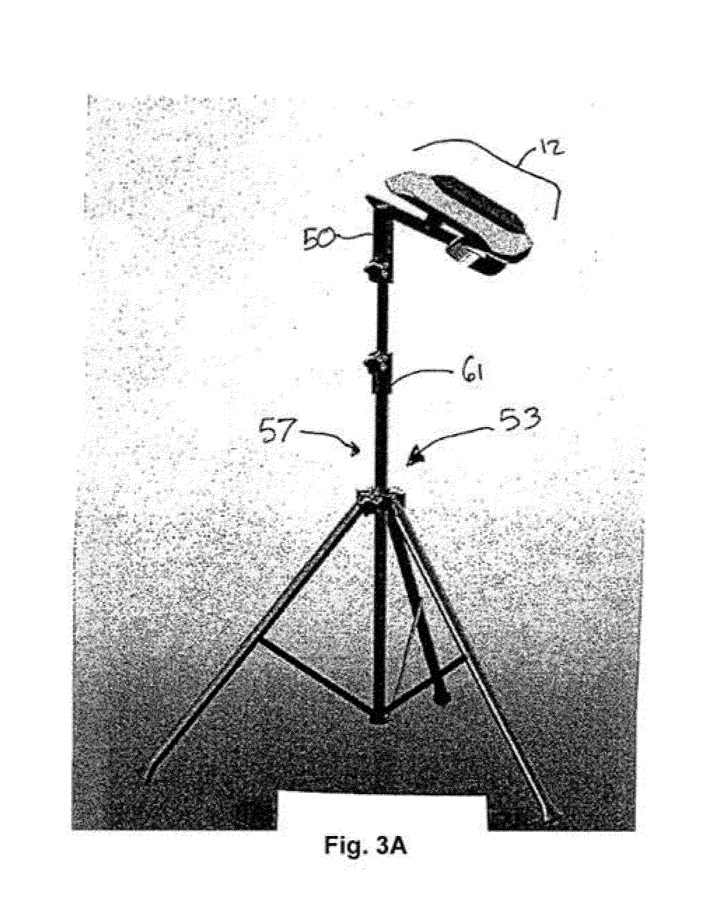

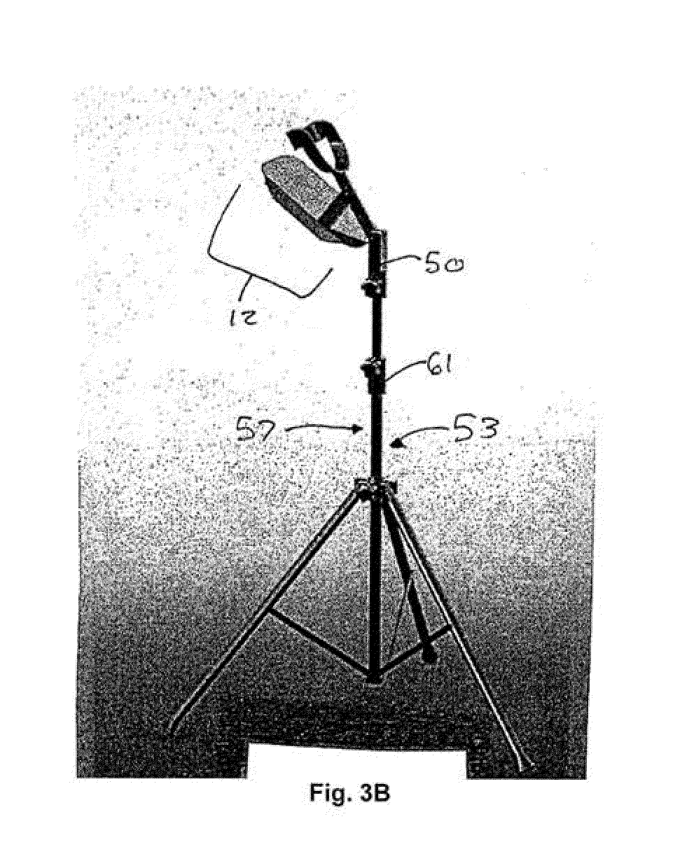

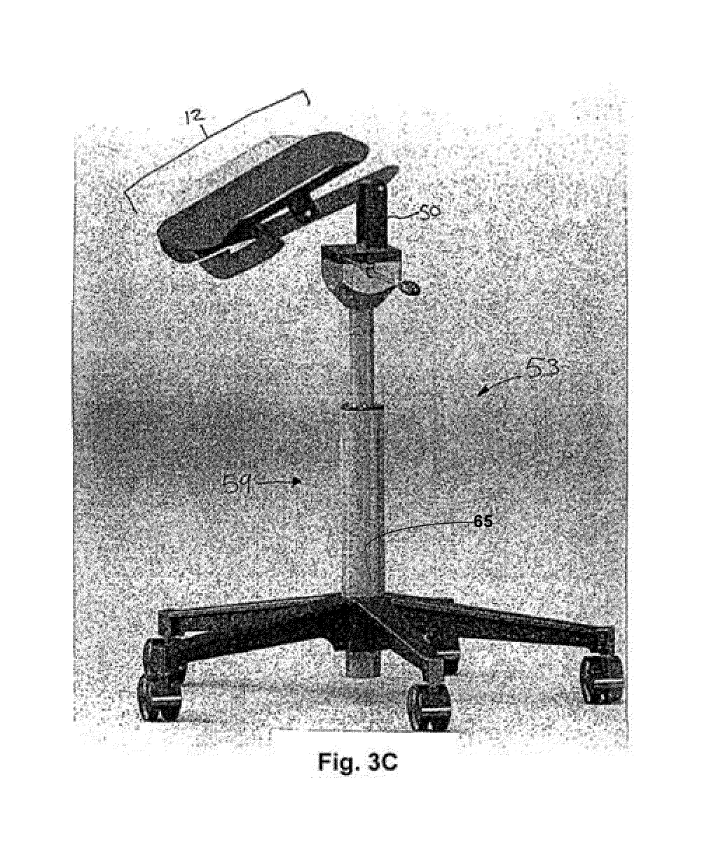

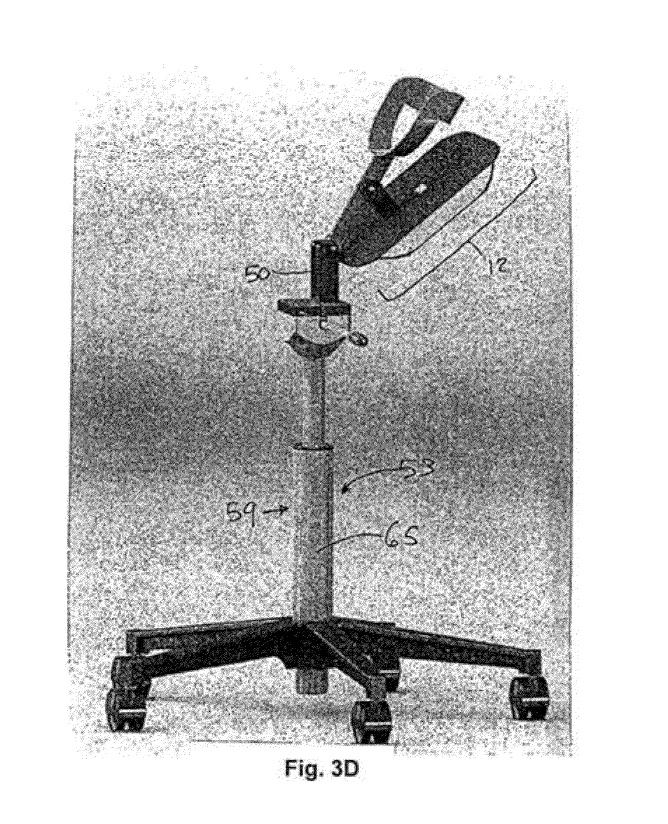

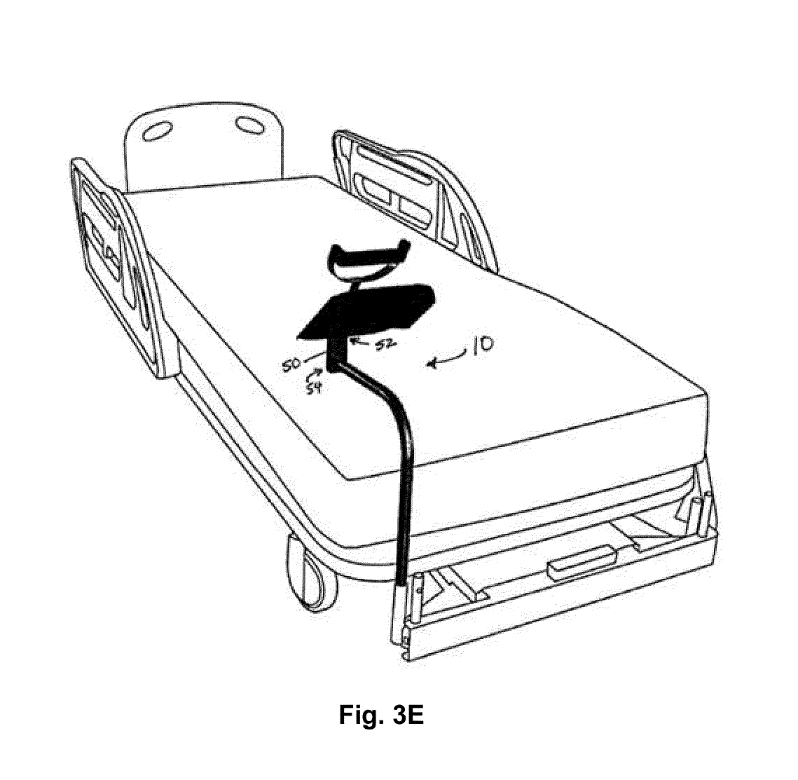

In another example, FIGS. 3A and 3B each show a representative embodiment in which the attachment member 50 is coupled to a tripod 57. In still another example, FIGS. 3C and 3D each show a representative embodiment in which the attachment member 50 is coupled to a wheeled base 59. In yet another example, FIG. 3E shows an embodiment in which the wound care apparatus 10 is connected (e.g., via the attachment member 50) to a bed (e.g., an articulated bed, a hospital bed, a non-articulated bed, etc.) that is capable of supporting wound care apparatus 10 and a patient's leg.

Where the support structure 53 comprises a mobile support structure, such as a tripod, a wheeled base, a cart, etc., the support structure 53 may provide the wound care apparatus 10 with several beneficial features. In one example, where the wound care apparatus 10 is coupled to a mobile support structure 53 and a patient is supported on a separate and discrete patient support device (e.g., as a chair, table, bed, or other object that is capable of supporting a patient), a healthcare provider can easily and quickly the move support structure 53, and hence the wound care apparatus 10, to a wide variety of locations. In another example, where the wound care apparatus 10 couples (e.g., via the attachment member 50 or otherwise) to a mobile support structure 53, the wound care apparatus 10 does not necessarily need to be coupled to a specialized patient support device (e.g., a relatively expensive articulating chair). Thus, in some embodiments, a healthcare provider can carry the wound care apparatus to the patient (e.g., the patient's home), while allowing the patient to be supported on a variety of discrete patient support devices (e.g., a conventional chair, bed, etc.).

The attachment member 50 can attach to the support structure 53 in any suitable manner, including, without limitation, through the use of one or more welds, mechanical engagements, frictional engagements, couplers, straps, clamps, mating engagements, adhesives, mounting plates, receivers, and/or other suitable mechanisms. Accordingly, while some embodiments of the wound care apparatus 10 are permanently attached to the support structure 53, other embodiments are selectively attachable to and detachable from the support structure 53. Additionally, in some embodiments, the wound care apparatus 10 is configured to be retrofit to one or more of a variety of support structures.

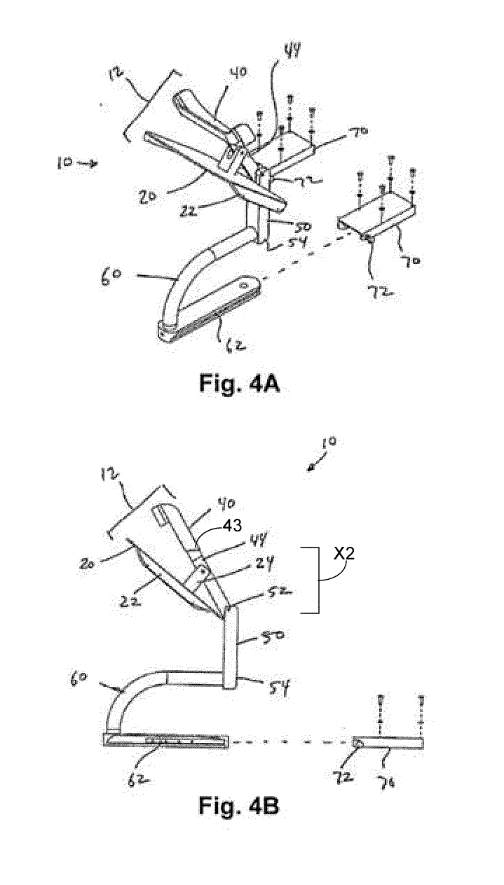

In some embodiments, the attachment member 50 attaches to the support structure 53 via a coupler 62 that is configured to attach the wound care apparatus 10 to a desired surface via a receiver 70. In such embodiments, the coupler can function in any suitable manner. By way of illustration, FIGS. 4A and 4B show some embodiments in which the coupler 62 comprises an extended track having grooves for slidably inserting with the receiver 70. Accordingly, in some embodiments, the receiver 70 comprises a set of rails or pins configured to seat within the grooves of the coupler 62 such that the coupler is capable of being laterally adjusted within the receiver 70 in a forward (e.g., distal) and rearward (e.g., proximal) direction (including, without limitation, perpendicularly to a width of the chair or other support object). In some embodiments, the receiver 70 further comprises a set pin 72 that is capable of being inserted into the coupler 62 thereby arresting a position of the coupler 62 within the receiver 70. Accordingly, some such embodiments provide an adjustable wound care apparatus 10 configured to accommodate patients and/or healthcare providers of various heights. Similarly, some embodiments allow the healthcare provider to adjust the position of the first surface (e.g., by adjusting the coupler 62 within the receiver 70 or otherwise adjusting the wound care apparatus 10) so that first surface 20 is properly aligned with the patient's 14 calf. Also, in some embodiments, an arched or other contoured configuration of the extension arm 60 permits rearward positioning of the coupler 62 within the receiver 70 without causing contact between the attachment member 50 and the leg rest 82 (or another portion of the support structure 53).

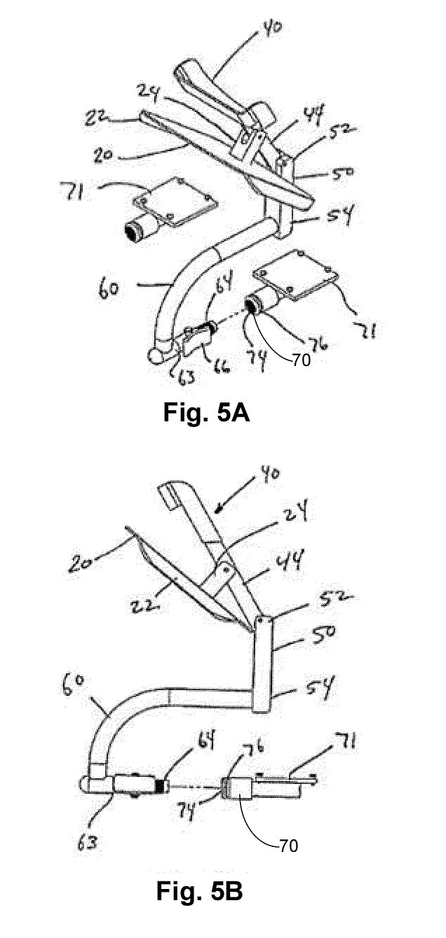

In other embodiments, as shown in FIGS. 5A and 5B, the coupler 63 comprises a set of male key splines 64 and the receiver 70 comprises a set of female key splines 74 configured to compatibly receive the male key splines 64. In some embodiments, the coupler 63 further comprises a latch or locking clip 66 configured to selectively engage a retaining feature 76 (e.g., groove, orifice, process, member, etc.) located on an external surface of the receiver 70. Thus, an engagement between the clip 66 and the retaining feature 76 is able to secure the wound care apparatus 10 to the support structure 53 (e.g., articulated chair 80 via leg rest 82).

In some embodiments, where the support structure 53 comprises a patient support device (e.g., a chair, table, bed, etc.), the attachment member 50 is connected to the support structure's right side, left side, or can be switched between the two sides. In one non-limiting example, the support structure (e.g., a bed, chair, leg rest 82, etc.) comprises both a left and a right receiver 70, thus permitting the wound care apparatus to be mounted on either side of the support structure 53. As such, a single wound care apparatus may be used to treat both the left and right legs of the patient.

In place of, or in addition to, the coupler (e.g., couplers 62 and/or 63), the attachment member 50 can adjustably couple to the support structure 53 in any other suitable manner. Indeed, in some embodiments, the attachment member 50 couples to support the structure via a joint (e.g., pivot joint, a ball-and-socket joint, a slip joint, etc.); a threaded member that raises or lowers the leg support 12 as the threaded member is twisted with respect to the support structure; a pneumatic cylinder; a clamp; a ratcheting device that allows the leg support 12 to be raised and locked into one or more positions, and then to be lowered by raising the device past a set point; or any other suitable adjustable mechanism that allows the wound care apparatus 10 to be adjustably coupled to the support structure. In one example, the second end 54 the of attachment member is adjustably coupled to the support structure (e.g., the extension arm 60) via a pivot joint which provides for axial rotation of attachment member relative to a fixed position of the support structure (e.g., the extension arm). In some other non-limiting embodiments, FIGS. 3A and 3C respectively show embodiments in which the attachment member 50 is adjustably coupled to the support structure 53 via a slip joint 61 and a pneumatic cylinder 65.

While the wound care apparatus 10 is in the first position, the healthcare provider may treat the foot and ankle of a patient without being required to manipulate, lift, handle, reposition, or hold patient's 15 leg. Further, in some embodiments, the wound care apparatus eliminates the need for the healthcare provider to acquire assistance from additional healthcare providers or technicians to treat the foot and ankle of the patient 14. Thus, the some embodiments of the wound care apparatus overcome the previously discussed limitations inherent in at least some of the prior art.

With continued reference now to FIGS. 5A and 5B, in some embodiments, the wound care apparatus 10 further comprises a second position, as shown. According to some embodiments, the second position is characterized by the leg support 12 portion of the apparatus being pivotally rotated in a forward (e.g., distal) direction such that the first surface 20 is faced in an approximately downward direction, and the second surface 40 of the leg support is made accessible to the patient 14.

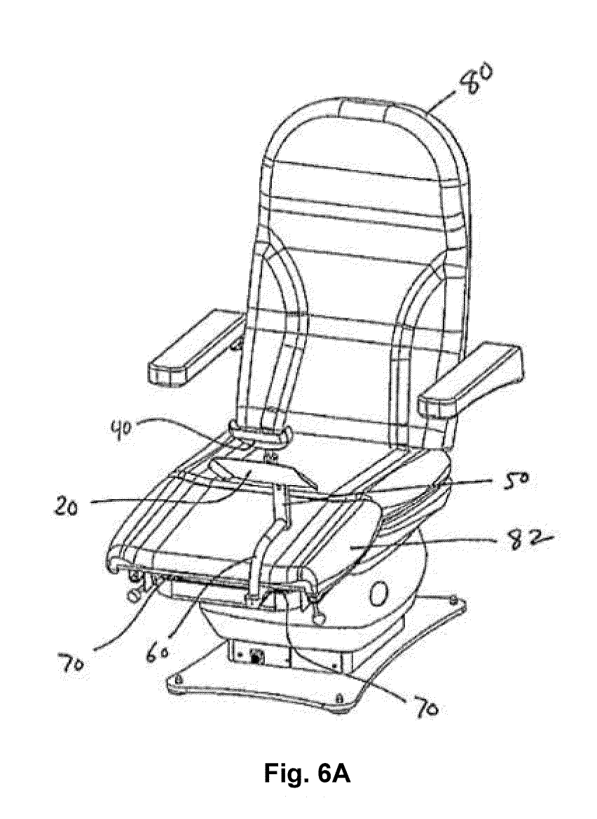

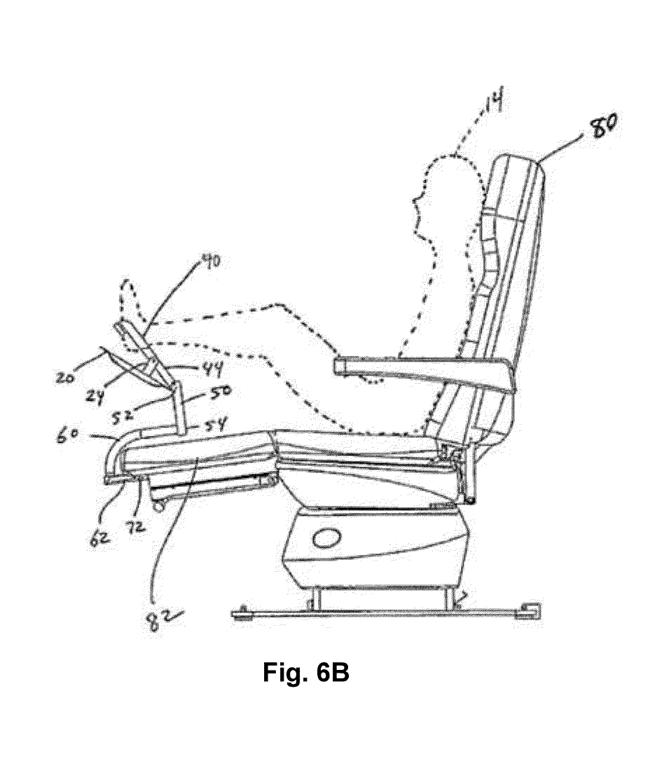

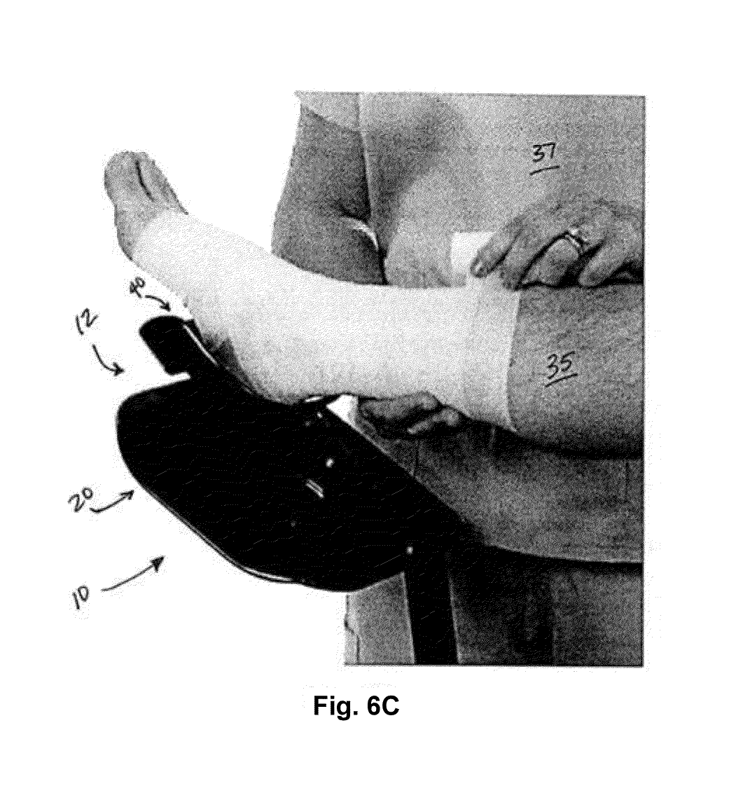

While the second surface 40 can comprise any suitable component or character that allows it to directly support a lower portion of the patient's leg (e.g., foot and/or ankle). In some embodiments, the second surface 40 comprises a heel stirrup (including, without limitation, an oversized stirrup) and/or any other suitable structure for receiving and/or directly supporting heel and/or foot portions of the patient's leg, as shown in FIGS. 6A through 6C.

In some embodiments, the hinged or pivoting connection between the first end 52 of the attachment member 50 and the support strut 44 is configured such that the rotation of the leg support 12 is limited. Indeed, in some embodiments, the rotation of the leg support 12 is limited to a range of approximately 120° between the first position and the second position. In still other embodiments, the rotation of the leg support is limited to a range of rotation that is less than an amount selected from about 360°, about 180°, about 150°, and about 100°. In still other embodiments, the rotation of the leg support between the first position and the second position is limited to a range of rotation that falls in any suitable sub-range of the aforementioned ranges. In yet other embodiments, however, the hinged or pivoting connection is adjustable such that a user can increase or decrease the range of rotation between the first and second positions, as may be desired.

With continued reference to FIGS. 6A through 6C, when the wound care apparatus 10 is in the second position, as shown, the second surface 40 is made available to support the heel and/or sole portions of the patient's foot. Accordingly, when the patient's leg is supported by the apparatus, the upper ankle and/or calf portions of the patient's lower leg are suspended in air, thereby providing the healthcare provider with 360° access to the patient's 14 upper ankle and calf. Thus, in some embodiments, when the patient's leg 35 is supported in such a manner, the healthcare provider 37 is able to freely wrap or otherwise attend to any part of the patient's leg that is not in direct contact with a surface of the wound care apparatus (e.g., the second surface 40). Thus, while the leg support 12 is in the second position, the healthcare provider is able to treat the upper ankle and calf of the patient 14 without being required to manipulate, lift, handle, reposition, or hold the patient's leg. Further, some embodiments of the wound care apparatus eliminate the need for the healthcare provider to acquire assistance from additional healthcare providers or technicians to treat patient's 14 leg. Thus, some embodiments of the wound care apparatus further overcome the previously discussed limitations inherent in at least some of the prior art.

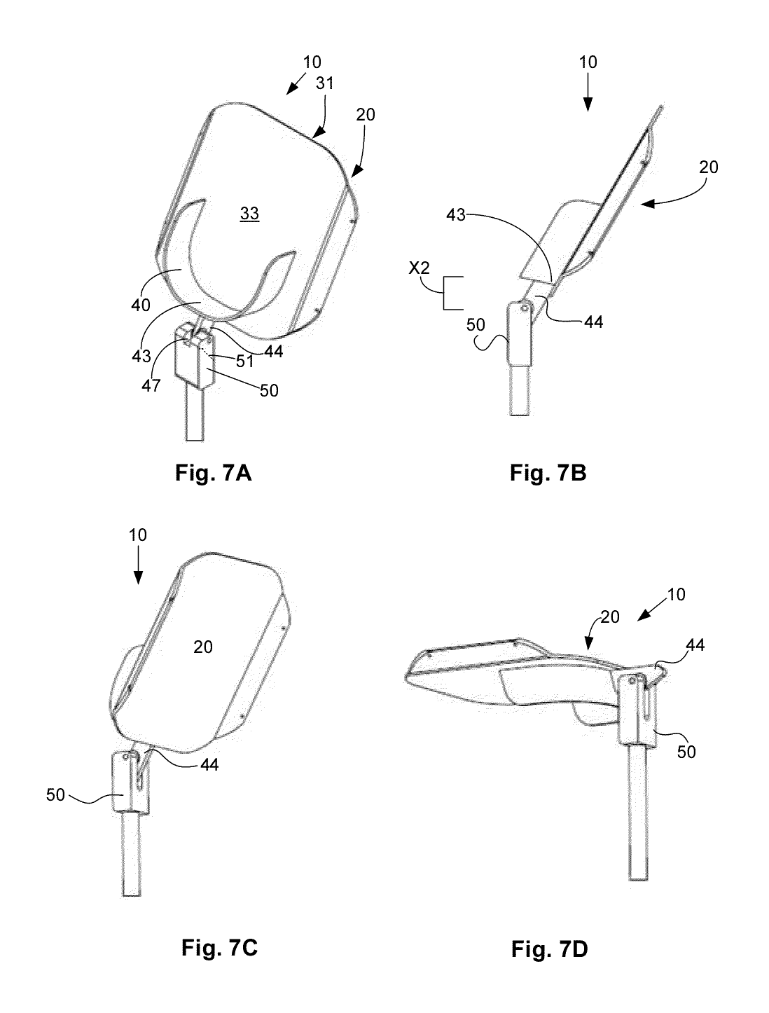

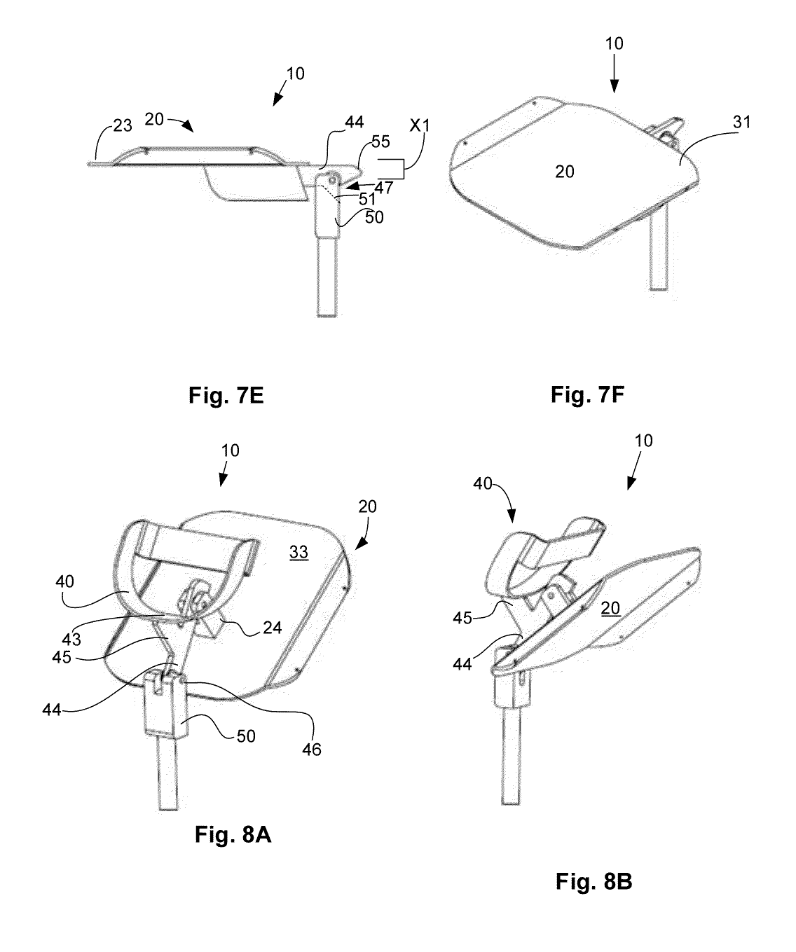

The described wound care apparatus 10 can be modified in any suitable manner that allows it to move between the first position and the second position to support a patient's calf and heel/foot, respectively. By way of illustration, FIGS. 7A-7F show that, in some embodiments of the wound care apparatus 10, the first surface 20 (e.g., the calf support surface) of the leg support 12 is connected (integrally or otherwise) to the second surface 40 (e.g., a heel/foot support surface). Specifically, FIGS. 7A-7F show the first surface 20 comprises a front side 31 for supporting the patient's calf and an underside 33 to which the second surface 40 is attached.

Where the second surface 40 is fixed to the underside 33 of the first surface 20, the leg support 10 can attach to the attachment member 50 in any suitable manner. By way of non-limiting illustration, FIGS. 7A-7C show some embodiments in which the support strut 44 extends from the second surface 40 and pivotally attaches near its terminal end to the attachment member 50. In this manner, the leg support can easily be pivoted between the first position (shown in FIGS. 7D-7F) and the second position (shown in FIGS. 7A-7C).

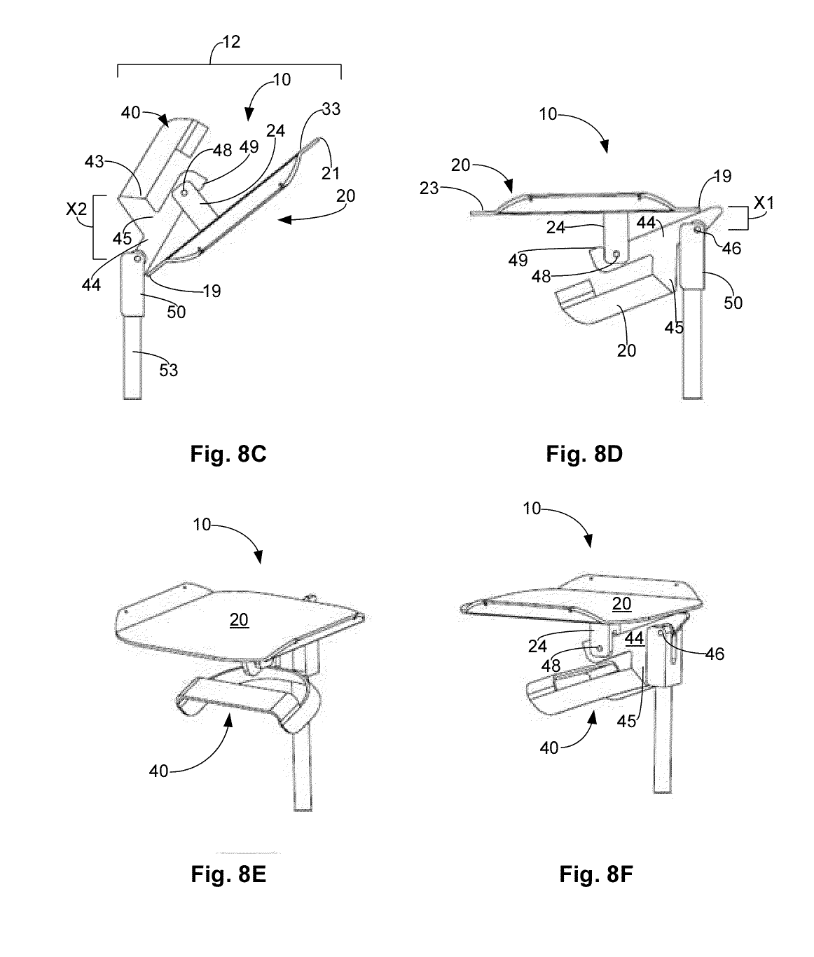

In another example showing how the wound care apparatus 10 can be modified, FIGS. 8A-8F show that, in some embodiments, the first surface 20 is pivotally connected (e.g., via the connector 24) to the support strut 44, while the second surface 40 is connected (e.g., fixedly or otherwise) to the support strut. Indeed, unlike the wound care apparatus 10 shown in FIG. 1B in which the second surface 40 is disposed at a second end of the support strut 44, FIGS. 8C and 8D show some embodiments in which the second surface 40 is held by a branch member 45 that extends from the support strut 44.

While the branch member 45 can extend from the support strut 44 in any suitable location, in some embodiments, the branch member extends from the support strut between the pivot joint 46 that attaches the support strut to the attachment member 50 and the pivot joint 48 that attaches the first surface 20 (e.g., via the connector 24) to the support strut. Additionally, while the branch member can extend from any side of the support strut, FIG. 8C shows some embodiments in which the branch member 45 extends from a side of the support strut 44 that faces the patient (e.g., faces proximally) when the leg support 12 is in the second position.

Additionally, FIG. 8C shows that while the range of motion of the first surface 20 can be limited with respect to the support strut 44 in any suitable manner, in some embodiments, the support strut 44 itself is configured limit the first surface's range of motion. Indeed, while the support strut can have any suitable characteristic that allows it to limit the first surface's range of motion, FIG. 8C shows some embodiments, in which the support strut 44 comprises a raised contact surface 49 that is configured to contact the underside 33 of the first surface 20, proximal to the connector 24. Additionally, FIG. 8C shows that, in some embodiments, the distal end 19 of the first surface 20 is configured to contact the support strut 44 (or another portion of the apparatus 10) to limit the first surface's range of motion.

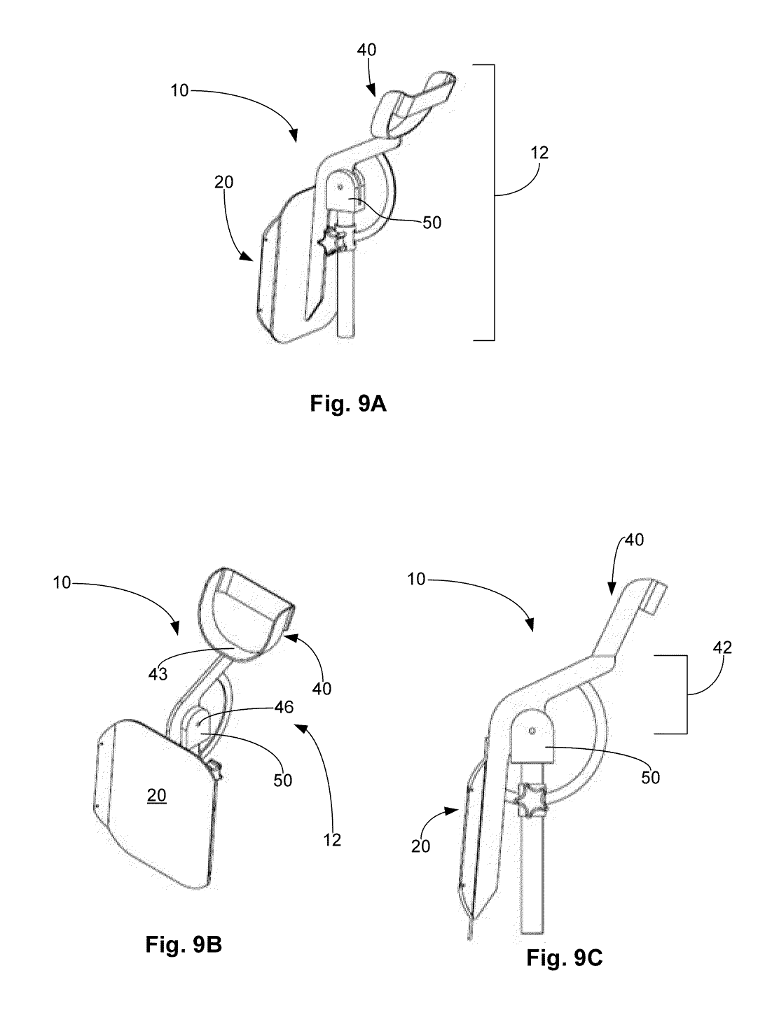

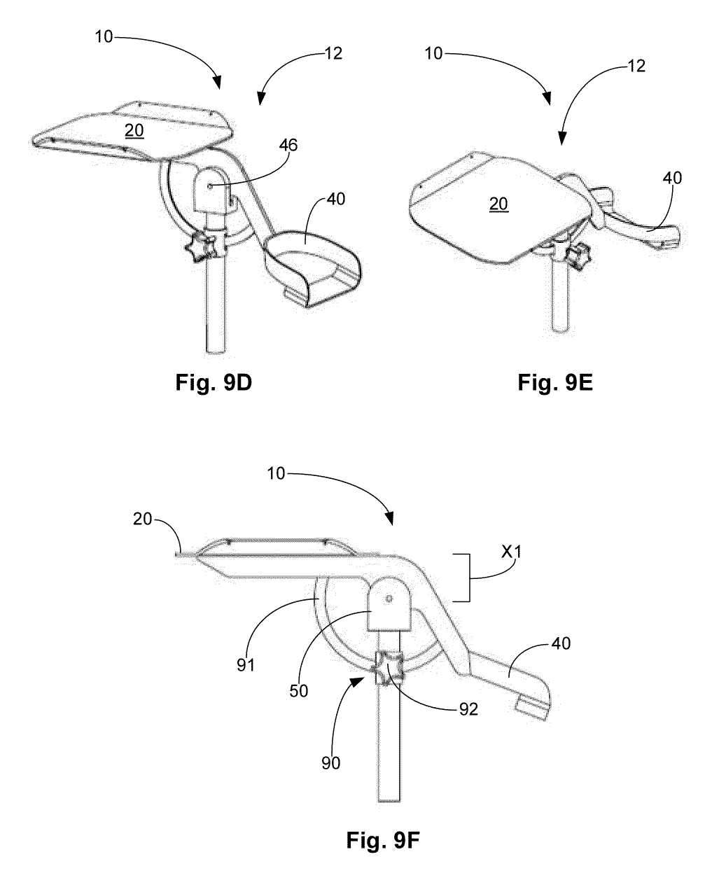

In still another example showing how the wound care apparatus 10 can be modified, FIGS. 9A-9F show that, in some embodiments, the first surface 20 (e.g., the calf support) is disposed near a first end (e.g., the proximal end) of the leg support 12, while the second surface 40 (e.g., the heel/foot support) is disposed near a second end (e.g., the distal end) of the leg support. In such embodiments, the leg support can comprise any suitable characteristic that allows it to be moved between the first and second position (or to any position in between the first and second positions). Indeed, in some embodiments (as shown in FIG. 9A), the leg support 12 comprises a pivot joint 46 that is disposed between at least a portion of the first surface 20 and the second surface 40, such that leg support forms a first class lever. Additionally, while the first surface and the second surface can have any suitable relation to each other with respect to their placement, FIGS. 9A, 9C, and 9F show that, in some embodiments, the leg support 12 is bent, curved, angled, or otherwise shaped such as the first surface is raised, the second surface is lowered, and vice versa.

In still another example of how the wound care apparatus 10 can be modified, some embodiments of the apparatus are configured to allow the patient's foot to be retained in substantially the same location (e.g., height from the floor) when the leg support 12 is in the first position as when the leg support is in the second position. While this can be accomplished in any suitable manner, in some embodiments, the leg support is configured such that a portion of the first surface 20 (e.g., a lowest portion, a portion directly above the connector 24, a highest portion, etc.) is lower when the leg support is in the first position, than is a portion (e.g., e.g., a lowest portion, a highest portion, etc.) of the second surface 40 when the leg support is in the second position. By way of non-limiting illustration, FIGS. 1B and 4B, 7E and 7B, 8D and 8C, and 9C and 9F show some embodiments in which the lowest support portion 23 of the first surface 20 (or the front side 31 of the first surface) are lower (as shown by element X1) in the first position than is the lowest support portion 43 of the second surface 40 when the leg support is in the second position (as shown by element X2).

While having the first surface 20 (e.g., the lowest support portion 23 of the first surface) be lower in the first position than is the second surface (e.g., the lowest support portion 34 of the second surface) in the second position may provide the leg support 12 with several beneficial characteristics. Indeed, in some embodiments, such a configuration can allow the patient's heel to be in substantially the same location (e.g., height) when the leg support is in the first position as it is in the second position. Additionally, by having the first and the second surfaces have the described configuration, some embodiments of the described apparatus 10 allow a patient to retain his or her leg in substantially the same orientation (e.g., in a fully extended, or mostly extended orientation) when the leg is being supported in both the first and the second positions. Indeed, the skilled artisan will recognize that if the first surface were at the same height or higher when the leg support is in the first position than is the second surface when the leg support is in the second position, then (in at least some embodiments) the patient's calf (and the relatively proximal positioning of the first surface on the patient's leg) would cause the patient's heel to be raised (when the leg is supported in the first position) above the height at which the heel would be held when the leg is supported in the second position.

Where the first surface 20 (e.g., the lowest support portion 23) is lower in the first position than is the second surface 40 (e.g., the lowest support portion 43) in the second position, the first surface can be any suitable amount lower in the first position than is the second surface in the second position. Indeed, in some non-limiting embodiments, when the leg support is in the first position, the first surface (e.g., the lowest support portion) is between about 1 mm and about 40 cm below the second surface (e.g., the lowest support portion) when the leg support is in the first position. In still other embodiments, a portion of the first surface is configured to be between about 1 cm and about 15 cm lower in the first position than is a portion of the second surface in the second position. In yet other embodiments, a portion of the first surface (e.g., the lowest support portion 23) is configured to be between about 3 cm and about 12 cm lower in the first position than is a portion of the second surface (e.g., the lowest support portion 43) in the second position. In still other embodiments, the first surface can be any other suitable amount lower in the first position than is the second surface in the second position, including, without limitation, by any amount that falls within any of the aforementioned ranges.

As yet another example of how the wound care apparatus 10 can be modified, the apparatus can comprise or can be modified to comprise any characteristic that allows it to be selectively retained in and released from both the first and the second positions. In this regard, the described wound care apparatus can be retained in a desired position (e.g., in the first position, the second position, any suitable position between the first and the second position, etc.) through any suitable mechanism, including, without limitation, through the configuration of the support strut 44 and the attachment member 50, a ratchet mechanism, a clamping mechanism, gravity, a frictional engagement, a set pin, a weldment, and/or any other suitable mechanism.

In one example, FIG. 9F shows a representative embodiment in which the leg support 12 comprises a clamping mechanism 90 that is configured to retain the leg support in a desired location. While the clamping mechanism can function in any suitable manner, FIG. 9F shows an embodiment in which the clamping mechanism 90 comprises a rail 91 and clamping member 92. In such embodiments, the clamping member can be tightened (e.g., by being twisted in a first direction, where the clamping member comprises a threaded member) to lock the leg support in a desired location, or can be loosened (e.g., by being twisted in a second direction) to allow the first surface 20 and second surface 40 to be repositioned.

In another example of how the leg support 12 can be selectively retained in a desired position, the support strut 44 and attachment member 50 are configured to perform such a function. While the support strut and attachment member can be configured in any suitable manner that allows the apparatus 10 to function as intended, FIGS. 7A and 7E show some embodiments in which the support strut 44 is pivotally received within a recess 47 in the attachment member. In some embodiments, an interior surface (as shown by dotted line 51) of the recess 47 is angled such that when the leg support 12 is rotated into the first position (e.g., as shown in FIG. 7E), a portion of the support strut 44 contacts an upper portion of the interior surface, and such that when the leg support is in the second position (as shown in FIG. 7A), a tongue 55 on the support strut contacts the interior surface.

In still another example of how the leg support 12 can be selectively retained in a desired position, in some embodiments, the angle of the support strut 44 with respect to the attachment member 50 helps selectively retain the leg support in a desired position (e.g., the first position). In this regard, the support strut can be at any suitable angle with respect to the attachment member when the leg support is in the first position. Indeed, in some embodiments (as shown in FIG. 2B), when the leg support is in the first position, the longitudinal axis 41 of the support strut runs at an angle that is less than about 120° with respect to a longitudinal axis 100 of the attachment member 50. In other embodiments, the longitudinal axis of the support strut runs at an angle that is between about 1° and about 95° with respect to the longitudinal axis of the attachment member. In still other embodiments, the longitudinal axis of the support strut runs at an angle that is between about 30° and about 85° with respect to the longitudinal axis of the attachment member. In yet other embodiments, when the leg support is in the first position, the longitudinal axis of the support strut runs at any other suitable angle that falls within the aforementioned ranges.

The described wound care apparatus 10 can be used in any suitable manner that allows it to directly support one or more lower portions of a patient's leg (e.g., calf and foot). In this regard, although in some embodiments, the wound care apparatus is first used in the second position, in some other embodiments, the wound care apparatus is first used in the first position. In some such embodiments, with the leg support 10 in the first position, a healthcare provider first positions the patient's calf on the first surface 20 of the leg support 12 and wraps or otherwise treats or examines the suspended portions of the patient's lower leg (e.g., the patient's foot, heel, ankle, and/or other exposed portion). To treat the non-suspended portions of the patient's leg, the healthcare provider rotates the leg support 12 to the second position, thereby exposing the second surface 40. In some embodiments, the healthcare provider then places the patient's heel and/or foot on the second surface 40 (e.g., the heel or foot stirrup feature), thereby suspending the previously unsuspended portions (e.g., the calf) of the patient's lower leg. The healthcare provider is then able to treat the newly suspended portions of the patient's lower leg. This process can then be repeated as necessary. For instance, where the healthcare provider wraps a leg several times, the process can be repeated until the wrapping procedure is finished.

The wound care apparatus 10 can be formed from any suitable material or materials that allow the apparatus to function as intended. In this regard, some examples of suitable materials, include one or more metals (e.g., aluminum, stainless steel, metal alloys, etc.), polymers, ceramics, composites, woods, and/or other suitable materials. Indeed, in some embodiments, the apparatus comprises aluminum for a light-weight, yet strong support. Additionally, in some embodiments, the support surfaces (e.g., surfaces 20 and/or 40) comprise a coating or covering that allows the surfaces to be easily cleaned.

The wound care apparatus 10 can be manufactured in any suitable manner. Indeed, the various components of the apparatus can be formed in any suitable manner, including, without limitation, through any suitable molding, stamping, cutting, etching, extrusion, drilling, lathing, welding, bending, coating, connecting, and/or other suitable process. Moreover, some methods in accordance with the present invention comprise providing a leg support having a first position and a second position, wherein the first position presents a first surface to support a first portion of a patient's leg, and the second position presents a second surface to support a second portion of the patient's leg. Some methods further include positioning the first surface opposite the second surface with the leg support being hingedly coupled to an attachment member such that the leg support is hingedly moveable between the first and second positions, and such that when the leg support is in the first position, a lowest support portion of the first surface is lower than a lowest support portion of the second surface when the leg support is in the second position.

Some methods of the present invention further comprise a step for attaching the leg support 12 and/or attachment member 50 to a support structure 53 (e.g., a leg rest of a chair; a side of a bed, a table, etc.; a wheeled base; a tripod; etc.). Some methods of the present invention further include adjustably coupling a portion of the wound care apparatus'attachment member 50 to the support structure. Further still, some methods of the present invention comprise providing the attachment member with an extension arm 60, thereby accommodating adjustability of the apparatus' position relative to a portion the support structure (e.g., leg rest 82).

In addition to the aforementioned beneficial characteristics, the wound care apparatus 10 can comprise a variety of other features. In one example, in some embodiments in which the leg support 12 is attached to the attachment member 50 through the use of the pivot joint 46, the healthcare provider can easily move the leg support between the first and second positions with one hand. Additionally, as some embodiments of the support strut 44 are pivotally fixed with respect to the pivot joint 46 and do not allow any portion of the leg support to slide back and forth with respect to the pivot joint, the healthcare provider can move the leg support between the first and second positions with being forced to slide the leg support with respect to the pivot joint (as may be required in some conventional leg support systems).

As another example of a benefit of the described apparatus 10, in some embodiments, the healthcare provider is also able to adjust the position of the leg support 12 (e.g., by adjusting the position of the coupler 62 within the receiver 70, moving a mobile support structure, etc.) so that a desired position of patient's leg is maintained for a desired treatment. Indeed, in some non-limiting embodiments, the leg rest 82 is adjusted in a forward direction allowing the patient's leg to be extended, thereby accommodating a taller patient. Thus, some embodiments of the wound care apparatus 10 are configured and adjustable to fit the various anatomical features of a variety of patients.

Thus, embodiments of the present invention embrace a dual-function support providing (i) a calf support for wrapping the foot/heel of the patient and (ii) a heel support for wrapping the rest of the leg. Moreover, the apparatus can be easily moved to either the patient's left or right hand side for ease of wrapping or otherwise attending to either leg, heel and/or foot.

The present invention may be embodied in other specific forms without departing from its spirit or essential characteristics. The described embodiments and examples are all to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A wound care apparatus comprising:
a leg support having:
a first surface that is configured to support a calf of a patient's leg;
a second surface that is configured to support at least one of a heel and a foot of the patient's leg; and
a first pivot joint that allows the leg support to pivot between a first position that presents the first surface to support the patient's leg and a second position that presents the second surface to support the patient's leg, wherein the leg support is configured such that when the leg support is in the first position, a lowest support portion of the first surface is lower than a lowest support portion of the second surface when the leg support is in the second position.

2. The apparatus of claim 1, wherein the leg support comprises an elongated member having the first surface disposed near its first end and the second support surface disposed near its second end, and wherein the first pivot joint acts as a fulcrum between the first and second surface such that as the first surface is lowered as the second surface is raised and vice versa.

3. The apparatus of claim 1, wherein the second surface is fixed to an underside of the first surface, and wherein the second surface comprises a support strut that connects the leg support to an attachment member through the first pivot.

4. The apparatus of claim 1, wherein a support strut extends between the first pivot joint and the second surface, wherein the second surface comprises a connector that pivotally attaches the first surface to the support strut between the first pivot joint and the second surface.

5. The apparatus of claim 4, wherein the connector is disposed closer to a distal end of the first surface than it is to a proximal end of the first surface.

6. The apparatus of claim 4, wherein the connector is configured to only allow the first surface to rotate in a single plane of motion with respect to the support strut.

7. The apparatus of claim 4, wherein the first surface is able to pivot with respect to the strut support such that a longitudinal axis of the connector runs substantially perpendicular with a longitudinal axis of the strut support.

8. The apparatus of claim 1, further comprising a support strut that extends between the first pivot joint, which attaches the support strut to an attachment member, and a second pivot joint that attaches the first surface to the support strut, and wherein the second surface branches off from the support strut between the first and second pivot joints.

9. The apparatus of claim 1, wherein the leg support is attached to a support structure that is separate and discrete from a patient support device that is configured to support the patient as the patient's leg is supported by the wound care apparatus.

10. The apparatus of claim 9, wherein the support structure is configured to selectively raise and lower a height of the leg support.

11. A wound care apparatus comprising:
a leg support having:
a first surface that is configured to support a calf of a patient's leg;
a second surface that is configured to support at least one of a heel and a foot of the patient's leg; and
a first pivot joint that allows the leg support to pivot between a first position that presents the first surface to support the patient's leg and a second position that presents the second surface to support the patient's leg, wherein the leg support is configured such that the first surface contacts the calf of the patient's leg when the leg support is in the first position and the patient's leg is substantially extended, and such that the second surface contacts at least one of the heel and the foot when the leg support is in the second position and the patient's leg is substantially extended.

12. The apparatus of claim 11, wherein a support strut extends between the first pivot joint and the second surface, wherein the second surface comprises a connector that pivotally attaches the second surface to the support strut between the first pivot joint and the second surface.

13. The apparatus of claim 11, wherein the leg support is attached to a support structure that is separate and discrete from a patient support device that is configured to support the patient as the patient's leg is supported by the wound care apparatus.

14. The apparatus of claim 11, wherein the leg support is further configured such that when the leg support is in the first position, a lowest support portion of the first surface is lower than a lowest support portion of the second surface when the leg support is in the second position.

15. The apparatus of claim 11, wherein the first surface is configured to only pivot in a single plane with respect to the second surface.

16. A method for supporting a leg, the method comprising:
providing a leg support comprising:
a first surface that is configured to support a calf of a patient's leg;
a second surface that is configured to support at least one of a heel and a foot of the patient's leg; and
a first pivot joint that allows the leg support to pivot between a first position that presents the first surface to support the patient's leg and a second position that presents the second surface to support the patient's leg, wherein the leg support is configured such that when the leg support is in the first position, a lowest support portion of the first surface is lower than a lowest support portion of the second surface when the leg support is in the second position; and
supporting the patient's leg on the first surface when the leg support is in the first position.

17. The method of claim 16, wherein the patient's leg is in a substantially extended position when the patient's leg is supported on the first surface and the leg support is in the first position, and further comprising pivoting the leg support to the second position, and supporting the patient's leg on the second surface when the patient's leg is in the substantially extended position.

18. The method of claim 16, further comprising wrapping a bandage around a portion of the patients' leg.

19. The method of claim 16, further comprising keeping the patient's leg in substantially the same orientation when the patient's leg is supported by the first surface as it is when supported by the second surface.

20. The method of claim 16, further comprising supporting the patient on a patient support device and supporting the leg support on a support structure, wherein the support structure and the patient support device are separate and discrete from each other.
